(19) United States
(12) Patent Application Publication
(10) Pub. No.: US 2015/0269445 A1
(43) Pub. Date: Sep. 24, 2015

(54) TRAVEL DIVISION LINE RECOGNITION APPARATUS AND TRAVEL DIVISION LINE RECOGNITION PROGRAM

(71) Applicant: DENSO CORPORATION, Kariya-city (JP)

(72) Inventors: YUSUKE UEDA, Okazaki-shi (JP); NAOKI KAWASAKI, Kariya-shi (JP); SYUNYA KUMANO, Goteborg (SE); SHUNSUKE SUZUKI, Nukata-gun (JP); TETSUYA TAKAFUJI, Anjo-shi (JP)

(21) Appl. No.: 14/660,198

(22) Filed: Mar. 17, 2015

(30) Foreign Application Priority Data
Mar. 19, 2014 (JP) 2014-056075

(51) Int. Cl. G06K 9/00; G06T 7/00; B60R 1/00

(52) U.S. Cl. CPC G06K 9/00798; B60R 1/00; G06T 7/0085; B60R 2300/804; G06T 2207/30268; G06T 2207/30236

(57) ABSTRACT

In a travel division line recognition apparatus mounted in a vehicle, a dividing unit divides an area from which edge points, configuring a division line on a road, are extracted in a captured image of the road in the periphery of the vehicle into a nearby area within a predetermined distance from the vehicle and a distant area beyond the predetermined distance from the vehicle. An extraction area from which the edge points are extracted in a portion of the distant area is set. The edge points within the set extraction area are extracted. Distant road parameters are estimated based on the extracted edge points. An extraction area setting unit predicts a position of the division line in the distant area using a curvature of the road acquired in advance, and sets the extraction area so as to include the predicted position of the division line.

### CROSS-REFERENCE TO RELATED APPLICATION

This application is based on and claims the benefit of priority from Japanese Patent Application No. 2014-056075, filed Mar. 19, 2014, the disclosure of which is incorporated herein in its entirety by reference.

### BACKGROUND

1. [Technical Field]

The present disclosure relates to an apparatus and a program for recognizing a travel division line on a road to provide a vehicle with driving assistance and the like.

2. [Related Art]

Driving assistance, such as lane keeping and lane deviation warning, is performed using an apparatus that recognizes a division line, which are so-called white lines, on a road. In lane keeping, when an apparatus capable of recognizing even a distant division line with high accuracy is used, the accuracy of lane deviation prediction can be improved and lane keeping can be stably performed. Therefore, use of an apparatus that is capable of recognizing a distant lane division line with high accuracy is desired for lane keeping.

JP-A-2013-196341 proposes a travel division line recognition apparatus that recognizes a distant division line with high accuracy. In the travel division line recognition apparatus in JP-A-2013-196341, an extraction area for edge points of the division line is divided into a nearby area and a distant area. Nearby road parameters are calculated based on nearby edge points extracted from the nearby area, and then the position, in which a distant division line is present, is predicted based on the calculated nearby road parameters. From among distant edge points extracted from the distant area, the distant edge points are selected that correspond to the positions in which the division line is predicted to be present, and then distant road parameters are calculated using the selected distant edge points.

In JP-A-2013-196341, after the distant edge points are extracted, the distant edge points are narrowed down using the predicted position of the division line. However, the extraction area for the distant edge points is not narrowed down. Therefore, the calculation load of distant edge point extraction is large. However, if the extraction area for the distant edge points is merely reduced to reduce the calculation load, the distant division line may not be included in the extraction area. The recognition rate of a distant division line may decrease.

### SUMMARY

It is thus desired to provide a travel division line recognition apparatus that is capable of reducing calculation load and suppressing decrease in the recognition rate of a distant division line.

An exemplary embodiment provides a travel division line recognition apparatus that includes a dividing unit, an extraction area setting unit, a distant edge point extracting unit, and a distant road parameter estimating unit. The dividing unit divides an area from which edge points are extracted in an image of a road in the periphery of a vehicle that has been captured by a camera into two parts: one is a nearby area within a predetermined distance from the vehicle; and the other is a distant area beyond the predetermined distance from the vehicle. The edge points configure a division line on the road. The extraction area setting unit sets an extraction area from which the edge points are extracted in a portion of the distant area. The distant edge point extracting unit extracts the edge points within the extraction area set by the extraction area setting unit. The distant road parameter estimating unit estimates distant road parameters based on the edge points extracted by the distant edge point extracting unit. The extraction area setting unit predicts a position of the division line in the distant area using the curvature of the road that has been acquired in advance, and sets the extraction area so as to include the predicted position of the division line.

In the present disclosure, the area from which the edge points configuring a division line are extracted in an image acquired by an on-board camera is divided into two areas of which one is a nearby area within a predetermined distance from the vehicle and the other is a distant area beyond the predetermined distance from the vehicle. The extraction area from which the distant edge points are extracted is set in a portion of the distant area. The distant edge points within the set extraction area are then extracted, and the distant road parameters are estimated based on the extracted distant edge points.

Here, the extraction area for the distant edge points is set so as to include the position of the division line predicted using a road curvature that has been acquired in advance. Therefore, the risk of the distant division line being outside of the extraction area decreases. As a result, calculation load can be reduced, and decrease in the recognition rate of the division line in the distant area can be suppressed.

### BRIEF DESCRIPTION OF THE DRAWINGS

In the accompanying drawings:

FIG. 1 is a diagram of a configuration of a driving assistance system according to an embodiment;

FIG. 2 is a block diagram of the functions of a travel division line recognition apparatus;

FIG. 3 is a diagram for explaining pitching amount;

FIG. 4 is a flowchart of a process for estimating road parameters;

FIG. 5 is a flowchart of a process for recognizing a distant white line;

FIG. 6 is a diagram of an extraction area for distant edge points set on a straight road;

FIG. 7 is a diagram of an extraction area for distant edge points set on a curved road; and

FIG. 8 is a diagram of an extraction area for distant edge points.

### DESCRIPTION OF EMBODIMENTS

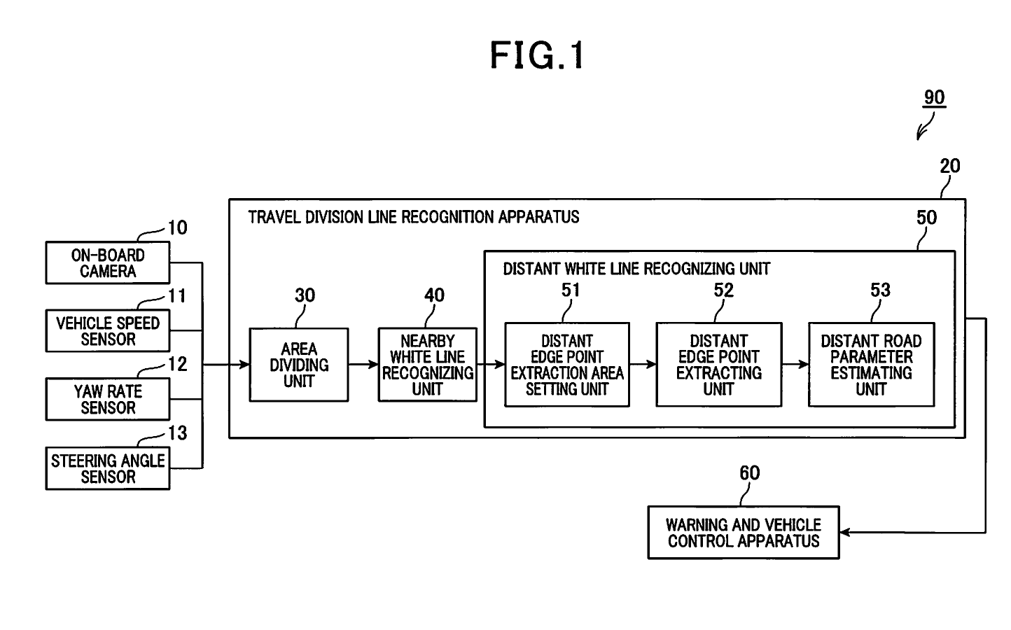

An embodiment of a travel division line recognition apparatus will hereinafter be described with reference to the drawings. First, a configuration of a driving assistance system 90 to which a travel division line recognition apparatus 20 according to the present embodiment is applied will be described with reference to FIG. 1.

The driving assistance system 90 includes an on-board camera 10, a vehicle speed sensor 11, a yaw rate sensor 12, a steering angle sensor 13, a travel division line recognition apparatus 20, and a warning and vehicle control apparatus 60. The vehicle speed sensor 11 measures the cruising speed of a vehicle. The yaw rate sensor 12 measures the yaw rate. The steering angle sensor 13 measures the steering angle of the vehicle.

The on-board camera 10 is a charge-coupled device (CCD) camera, a complementary metal-oxide-semiconductor (CMOS) image sensor, a near-infrared camera, or the like. The on-board camera 10 is mounted in the vehicle so as to capture images of the road ahead of the vehicle. Specifically, the on-board camera 10 is attached to the center in the vehicle-width direction of the vehicle, such as on a rear view mirror. The on-board camera 10 captures images of an area that spreads ahead of the vehicle over a predetermined angle range, at a predetermined time interval. Image information of the images of the road surrounding the vehicle that have been captured by the on-board camera 10 is transmitted to the travel division line recognition apparatus 20.

The travel division line recognition apparatus 20 is a computer that is composed of a central processing unit (CPU), a read-only memory (ROM), a random access memory (RAM), an input/output (I/O), and the like. The CPU runs a travel division line recognition program that is installed in the ROM, thereby performing various functions of an area dividing unit 30, a nearby white line recognizing unit 40, and a distant white line recognizing unit 50. The computer may also read out a travel division line recognition program that is stored on a recording medium.

The area dividing unit 30 divides an area from which edge points are extracted in the image acquired by the on-board camera 10 into two areas: a nearby area 71 an a distant area 72 (see FIG. 6). The edge points configure a white line (division line) on the road. The area from which the edge points are extracted is not limited to the overall image area, and refers to an area within a first distance from the vehicle. The nearby area 71 is an area within a second distance (predetermined distance) from the vehicle. The distant area 71 is an area beyond the second distance from the vehicle. The second distance is shorter than the first distance.

The nearby white line recognizing unit 40 extracts the edge points of a nearby white line from the nearby area 71, and then performs a Hough transform on the extracted nearby edge points and calculates a straight line of white line candidates. The nearby white line recognizing unit 40 narrows down the calculated white line candidates and selects a single white line candidate that is most likely to be a white line for each of the left and right sides. Specifically, the nearby white line recognizing unit 40 narrows down the calculated white line candidates to a white line candidate that is most likely to be a white line, taking into consideration the features of a white line, such as the edge strength being higher than a threshold, the edge points being aligned on a substantially straight line, and the thickness being close to a stipulated value.

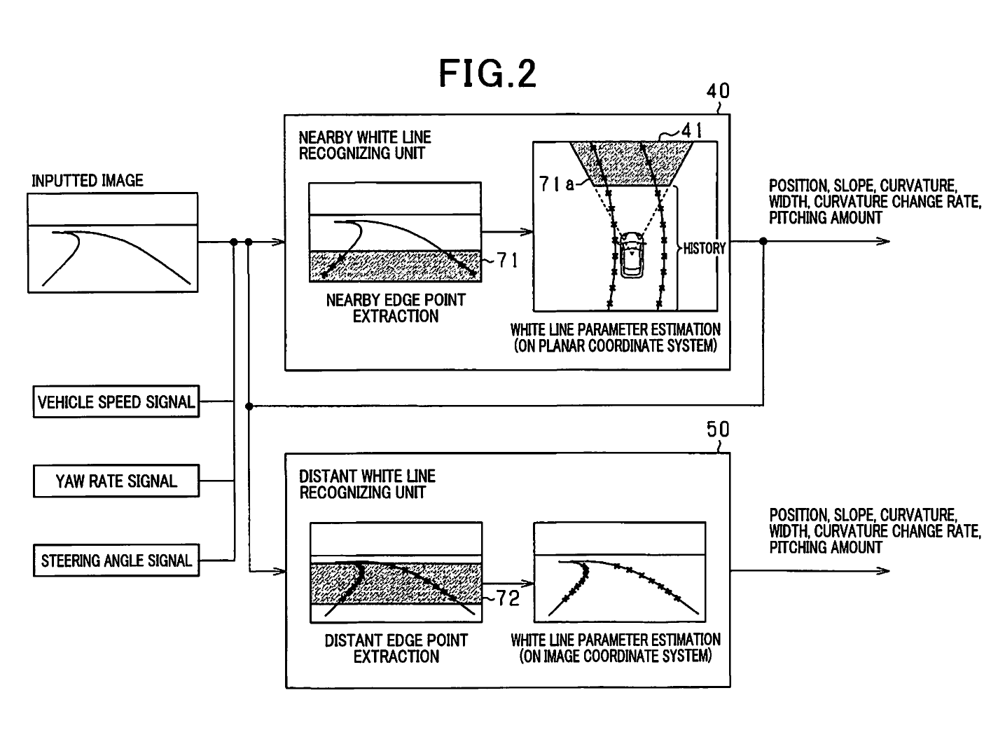

Furthermore, as shown in FIG. 2, the nearby white line recognizing unit 40 converts the nearby edge points on an image coordinate system that configures the selected white line candidate to nearby edge points on a planar coordinate system (bird's eye coordinates), under a presumption that the road surface is a planar surface. In accompaniment, the nearby area 71 on the image coordinate system is converted to a nearby area 71 a on the planar coordinate system. As a result of the nearby edge points being converted to information on the planar coordinate system, this information can be easily combined with coordinate information of edge points based on images that have been captured in the past.

Next, the nearby white line recognizing unit 40 calculates nearby road parameters using the nearby edge points on the planar coordinate system. The nearby road parameters include i) lane position, ii) lane slope, iii) lane curvature (road curvature), iv) lane width, v) curvature change rate, and vi) pitching amount.

i) The lane position is the distance from a center line that extends in the advancing direction with the on-board camera 10 at the center, to the center of the road in the width direction. The lane position indicates the displacement of the vehicle in the road-width direction. When the vehicle is traveling in the center of the road, the lane position is zero.

ii) The lane slope is a slope of a tangent of a virtual center line, which passes through the center of the left and right white lines, with respect to the advancing direction of the vehicle. The lane slope indicates the yaw angle of the vehicle.

iii) The lane curvature is a curvature of the virtual center line that passes through the center of the left and right white lines.

iv) The lane width is the distance between the left and right white lines in the direction perpendicular to the center line of the vehicle.

v) The lane width indicates the width of the road.

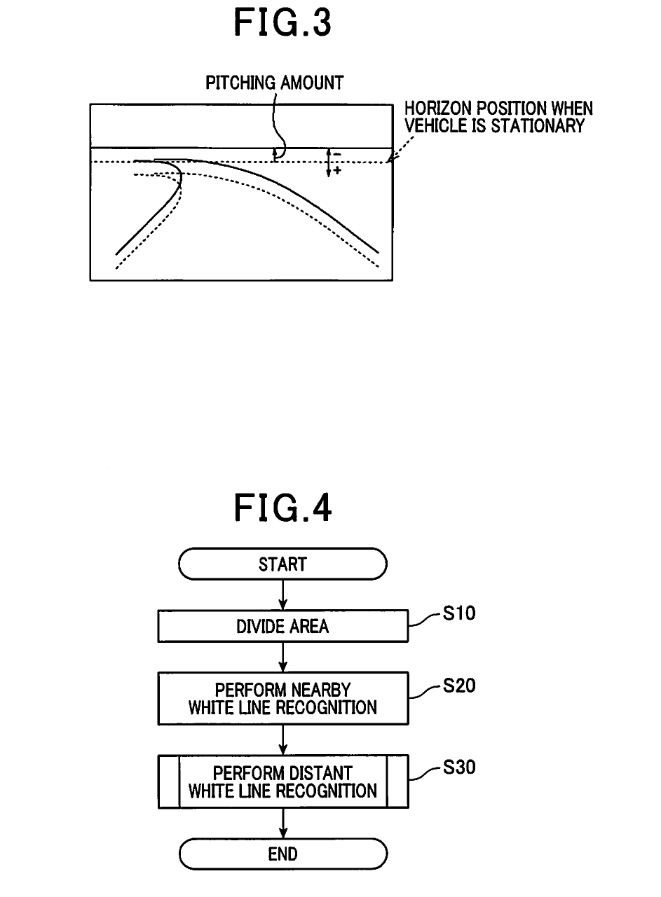

vi) The pitching amount is determined based on displacement in the vertical direction in the image with reference to a state in which the vehicle is stationary, as shown in FIG. 3.

Each of the above-described parameters is calculated based on the current extracted nearby edge points and nearby edge points (history edge points) extracted based on past images. In a planar image 41 in FIG. 2, the edge points within the nearby area 71a are the current extracted nearby edge points. The other edge points are the history edge points. The history edge points are calculated by moving the coordinates of the nearby edge points that have been extracted in the past, based on the measured vehicle speed and yaw rate.

The distant white line recognizing unit 50 includes a distant edge point extraction area setting unit 51, a distant edge point extracting unit 52, and a distant road parameter estimating unit 53.

The distant edge point extraction area setting unit 51 sets, in a portion of the distant area 72, a distant edge point extraction area from which distant edge points are extracted (see FIG. 6). Specifically, the distant edge point extraction area setting unit 51 predicts the position of the white line in the distant area 72 on the image coordinate system using the nearby lane curvature and curvature change rate calculated by the nearby white line recognizing unit 40. The distant edge extraction area setting unit 51 then sets the distant edge point extraction area so as to include the predicted position of the white line.

The distant edge point extracting unit 52 extracts the distant edge points within the distant edge point extraction area. Furthermore, the distant edge point extracting unit 52 narrows down the distant edge points that configure the distant white line from the extracted distant edge points, taking into consideration the various features of the white line.

The distant road parameter estimating unit 53 estimates the distant road parameters based on the distant edge points to which the extracted distant edge points have been narrowed down. Specifically, the distant road parameter estimating unit 53 estimates the distant road parameters using an extended Kalman filter, with the current calculated nearby road parameters as initial values. The estimated distant road parameters include the lane position, the lane slope, the lane curvature, the lane width, the curvature change rate, and the pitching amount.

The warning and vehicle control apparatus 60 performs driving assistance using the nearby road parameters and the distant road parameters estimated by the travel division line recognition apparatus 20. Specifically, the warning and vehicle control apparatus 60 calculates the distances between the vehicle and the left and right white lines based on the nearby road parameters. When the distance between the vehicle and either of the left and right white lines is shorter than a threshold, the warning and vehicle control apparatus 60 issues a lane deviation warning that warns the driver.

In addition, the warning and vehicle control apparatus 60 performs lane keeping control to assist in steering in alignment with the lane in the advancing direction of the vehicle, based on the distant road parameters. Furthermore, the warning and vehicle control apparatus 60 issues a collision warning to warn the driver when the distance to a leading other vehicle in the lane in which the vehicle is traveling becomes short.

Next, a process for estimating the road parameters will be described with reference to the flowchart in FIG. 4. The present process is performed by the travel division line recognition apparatus 20 each time the on-board camera 10 acquires an image.

First, the travel division line recognition apparatus 20 divides the area from which edge points are extracted in the image acquired by the on-board camera 10 into the nearby area 71 and the distant area 72 (step S10).

Next, the travel division line recognition apparatus 20 performs nearby white line recognition (step S20). First, the travel division line recognition apparatus 20 extracts the nearby edge points in the nearby area 71. In the nearby area 71 in which the accuracy of image information is high, the likelihood of noise being extracted is lower than that in the distant area 72. Therefore, the overall nearby area 71 is set as the extraction area for the nearby edge points. The travel division line recognition apparatus 20 then estimates the nearby road parameters based on the edge points configuring the nearby white lines, among the extracted edge points.

Next, the travel division line recognition apparatus 20 performs distant white line recognition and estimates the distant road parameters (step S30). The distant white line recognition process will be described in detail hereafter.

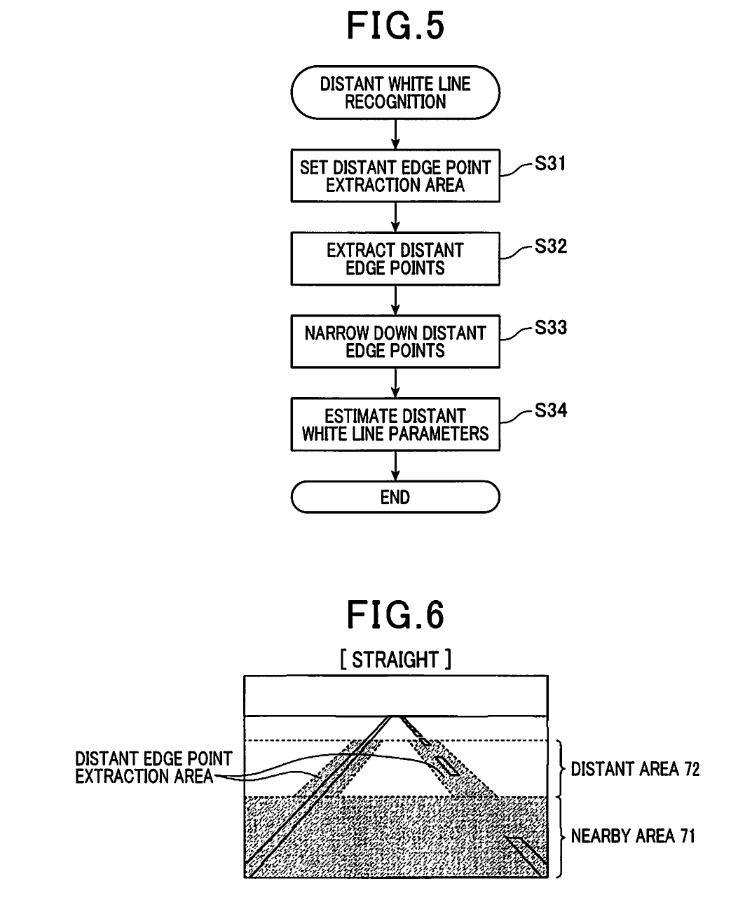

Next, the distant white line recognition process (step S30) will be described with reference to the flowchart in FIG. 5.

First, the travel division line recognition apparatus 20 predicts the positions of the white lines on the left and right sides in the distant area 72 using the lane curvature and the curvature change rate calculated by during nearby white line recognition (step S20). Then, the travel division line recognition apparatus 20 separately sets the distant edge point extraction areas for the left and right sides in portions of the distant area 72, so as to include the predicted positions of the white lines on the left and right sides. Specifically, the travel division line recognition apparatus 20 sets an area that has been widened by a predetermined number of pixels amounting to prediction error in the lateral width direction, with the position of each left and right white line at the center, as the distant edge point extraction area on each of the left and right sides.

Here, at step S20, the travel division line recognition apparatus 20 may calculate the curvatures of the white lines on the left and right sides as the respective lane curvatures. The travel division line recognition apparatus 20 may then separately set the distant edge point extraction areas corresponding to the white lines on the left and right sides, using the respective curvatures of the white lines on the left and right sides. As a result, the left and right distant edge point extraction areas can each be appropriately set.

Furthermore, the travel division line recognition apparatus 20 estimates a shifting amount of the white line in the distant area 72 in the vertical direction of the image, using the pitching amount calculated at step S20. The travel division line recognition apparatus 20 then sets the left and right distant edge extraction areas so as to be shifted in the vertical direction of the image by an amount equivalent to the estimated shifting amount.

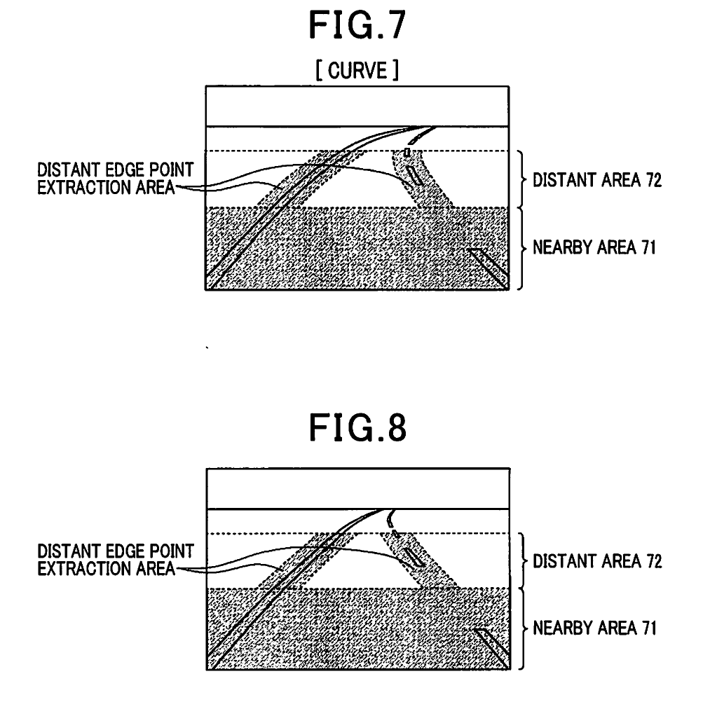

FIG. 6 shows a state in which the distant edge point extraction area is set on a straight road. FIG. 7 shows a state in which the distant edge point extraction area is set on a curved road. The distant edge point extraction area is set using the road curvature and the curvature change rate. Therefore, a distant edge point extraction area having a similar dimension as that on a straight road can be set even on a curved road so as to include the curved white lines.

In addition, the prediction error of the positions of the white lines in the distant area 72 may increase as the vehicle speed increases. Therefore, to extract the white lines with certainty, the predetermined number of pixels amounting to prediction error is increased and the lateral width of the distant edge point extraction area is set to be wider, as the speed measured by the vehicle speed sensor 11 increases.

Moreover, the prediction error of the positions of the white lines in the distant area 72 may increase as the steering angular velocity increases. Therefore, to reliably extract the white lines, the predetermined number of pixels amounting to prediction error is increased and the lateral width of the distant edge point extraction area is set to be wider, as the steering angular velocity calculated from the steering angle measured by the steering angle sensor 13 increases.

Furthermore, the prediction error of the positions of the white lines in the distant area 72 may increase as the distance from the vehicle increases. Therefore, to extract the white lines with certainty, the predetermined number of pixels amounting to prediction error is greater on the distant side of the distant edge point extraction area than on the nearby side. The lateral width on the distant side of the distant edge point extraction area is also set to be wider than that on the nearby side. Specifically, the lateral width of the distant edge point extraction area is set to be wider as the distance from the vehicle increases.

Still further, a search line used to search for the distant edge points in the distant edge point extraction area is set so that the number of pixels that are searched for the distant edge points during the distant edge point extraction becomes less than a predetermined number, regardless of the dimension of the distant edge point extraction area. When the search for edge points is performed in the horizontal direction of the image, the search line is a line in the horizontal direction of the image and indicates a position in the vertical direction of the image.

The search line can be set, at maximum, so as to amount to the number of pixels in the vertical direction included in the distant edge point extraction area. When the dimension of the distant edge point extraction area, or specifically, the lateral width of the distant edge point extraction area is wide, the number of pixels that are searched for the distant edge points increases if the search line is set to the maximum number of pixels. The calculation load may increase.

Therefore, the search line is set to be thinned out from the maximum number of search lines, enabling calculation load to become less than a predetermined amount even when the dimension of the distant edge point extraction area is wide. For example, the search line is set to be thinned out in every other line in the vertical direction. The accuracy of edge point information increases towards the nearby side. Therefore, the search line may be thinned out on the distant side of the distant edge point extraction area, and not thinned out on the nearby side.

In addition, when the dimensions of the distant edge point extraction areas on the left and right sides differ, search lines may be separately set for the distant edge point extraction areas on the left and right sides. In other words, the search lines may be respectively set so as to have mutually different intervals for the distant edge point extraction areas on the left and right sides.

Next, the travel division line recognition apparatus 20 searches for the distant edge points along the set search lines within the left and right distant edge point extraction areas set at step S31, and extracts the distant edge points (step S32).

Next, the travel division line recognition apparatus 20 narrows down the distant edge points that configure the distant white lines, from the distant edge points extracted at step S32 (step S33). Then, the travel division line recognition apparatus 20 estimates the distant road parameters based on the edge points to which the extracted edge points have been narrowed down at step S33 (step S34) and ends the present process.

According to the present embodiment described above, the following effects can be achieved.

The distant edge point extraction area is set so as to include the position of the white line predicted in the distant area 72, using the nearby lane curvature and curvature change rate estimated during nearby white line recognition. Therefore, the risk of the distant white line being outside of the distant edge point extraction area decreases. In addition, because the distant edge point extraction area is limited, the calculation load for extracting the distant edge points is reduced. Therefore, in addition to the reduction in calculation load, decrease in the recognition rate of white lines in the distant area 72 can be suppressed.

The shifting amount in the vertical direction of the image is estimated using the nearby pitching amount estimated during nearby white line recognition. The distant edge point extraction area is set so as to be shifted in the vertical direction of the image based on the estimated shifting amount. Therefore, decrease in the recognition rate of white lines in the distant area 72 can be further suppressed.

The prediction error of the position of the white line may increase as the vehicle speed increases. Therefore, as a result of the lateral width of the distant edge point extraction area being widened as the vehicle speed increases, decrease in the recognition rate of white lines in the distant area 72 can be further suppressed.

The prediction error of the position of the white line may increase as the steering angular velocity of the vehicle increases, or in other words, as the curve in the road becomes sharper. Therefore, as a result of the lateral width of the distant edge point extraction area being widened as the steering angular velocity of the vehicle increases, decrease in the recognition rate of white lines in the distant area 72 can be further suppressed.

The prediction error of the position of the white line may increase as the distance from the vehicle increases. Therefore, as a result of the lateral width of the distant edge point extraction area being widened as the distance from the vehicle increases, decrease in the recognition rate of white lines in the distant area 72 can be further suppressed.

The distant edge point extraction areas corresponding to the white line on the left side and the white line on the right side are separately set. Therefore, the distant edge point extraction areas are respectively set so as to be limited on the left and right sides. As a result, the dimension of the overall distant edge point extraction area decreases, and calculation load can be reduced. In addition, the extraction of noise between the left and right white lines is reduced, thereby improving the accuracy of white line recognition. Furthermore, when the left and right distant edge point extraction areas are respectively set using the curvatures of the white lines on the left and right sides, the left and right distant edge point extraction areas can each be appropriately set.

A search line used to search for the distant edge points is set in the distant edge point extraction area so that the number of pixels searched for the distant edge points during distant edge point extraction becomes less than a predetermined number. Therefore, even when the distant edge point extraction area is widened to increase the recognition rate of distant white lines, there is no risk of increase in calculation load.

### Other Embodiments

When the distant edge point extraction area is set, the lane curvature and curvature change rate acquired from a navigation apparatus may be used as the lane curvature and curvature change rate acquired in advance.

When the distant edge point extraction area is set, the lane curvature and curvature change rate estimated during the previous distant white line recognition operation may be used as the lane curvature and curvature change rate acquired in advance.

When the distant edge point extraction area is set, the weighted averages of the lane curvature and curvature change rate estimated during the current nearby white line recognition operation and the lane curvature and curvature change rate estimated during the previous distant white line recognition operation may be used as the lane curvature and curvature change rate acquired in advance. In this case, the weight of the estimation results of the current nearby white line recognition operation may be greater on the nearby side of the distant area 72, and the weight of the estimation results of the previous distant white line recognition operation may be greater on the distant side of the distant area 72.

When the distant edge point extraction area is set, the detection values from a height sensor that detects the heights of front and rear suspensions may be used as the pitching amount acquired in advance. The difference between the heights of the front and rear suspensions is set as the pitching amount.

When the distant edge point extraction area is set, the pitching amount estimated during the previous distant white line recognition operation may be used as the pitching amount acquired in advance.

When the distant edge point extraction area is set, the weighted average of the pitching amount estimated during the current nearby white line recognition operation and the pitching amount estimated during the previous distant white line recognition operation may be used as the pitching amount acquired in advance. In this case, the weight of the estimation result of the current nearby white line recognition operation may be greater on the nearby side of the distant area 72, and the weight of the estimation result of the previous distant white line recognition operation may be greater on the distant side of the distant area 72.

When the distant edge point extraction area is set, the curvature change rate acquired in advance may not be used. The distant edge point extraction area may be set using at least the lane curvature acquired in advance:

Although noise may increase compared to when the distant edge point extraction areas are respectively set so as to be limited on the left and right sides, the distant edge point extraction area may be set as an area that integrates the left and right sides.

The search line may be set not to be thinned out within the distant edge point extraction area, regardless of the dimension of the distant edge point extraction area. In this case as well, the calculation load of distant edge point search can be reduced compared to when the overall distant area 72 is searched.

What is claimed is:

1. A travel division line recognition apparatus mounted to a vehicle, comprising:
a dividing unit that divides an area from which edge points, configuring a division line on a road, are extracted in an image of the road in a periphery of the vehicle that has been captured by an on-board camera into a nearby area within a predetermined distance from the vehicle and a distant area beyond the predetermined distance from the vehicle;
an extraction area setting unit that sets an extraction area from which the edge points are extracted in a portion of the distant area;
a distant edge point extracting unit that extracts the edge points within the extraction area set by the extraction area setting unit; and
a distant road parameter estimating unit that estimates distant road parameters based on the edge points extracted by the distant edge point extracting unit, wherein
the extraction area setting unit predicts a position of the division line in the distant area using a curvature of the road that has been acquired in advance, and sets the extraction area so as to include the predicted position of the division line.

2. The travel division line recognition apparatus according to claim 1, wherein
the extraction area setting unit estimates a shifting amount of the division line in the distant area in a vertical direction of the image, using a pitching amount that has been acquired in advance, and sets the extraction areas so as to be shifted in the vertical direction of the image by an amount equivalent to the estimated shifting amount.

3. The travel division line recognition apparatus according to claim 2, wherein
the extraction area setting unit sets a lateral width of the extraction area to be wider as a speed of the vehicle increases.

4. The travel division line recognition apparatus according to claim 3, wherein
the extraction area setting unit sets a lateral width of the extraction area to be wider as a steering angular velocity of the vehicle increases.

5. The travel division line recognition apparatus according to claim 4, wherein
the extraction area setting unit sets a lateral width of the extraction area to be wider as a distance from the vehicle increases.

6. The travel division line recognition apparatus according to claim 5, wherein
the extraction area setting unit sets the extraction area so that a first extraction area corresponding to a first division line on a left side of the road and a second extraction area corresponding to a second division line on a right side of the road are separately set using a first curvature of the first division line and a second curvature of the second division line.

7. The travel division line recognition apparatus according to claim 6, wherein
the extraction area setting unit sets a search line used to search for the edge points in the extraction area so that the number of pixels for searching the edge points becomes less than a predetermined number, regardless of a dimension of the extraction area.

8. The travel division line recognition apparatus according to claim 1, wherein
the extraction area setting unit sets a lateral width of the extraction area to be wider, as a speed of the vehicle increases.

9. The travel division line recognition apparatus according to claim 1, wherein
the extraction area setting unit sets a lateral width of the extraction area to be wider, as a steering angular velocity of the vehicle increases.

10. The travel division line recognition apparatus according to claim 1, wherein
the extraction area setting unit sets a lateral width of the extraction area to be wider, as a distance from the vehicle increases.

11. The travel division line recognition apparatus according to claim 1, wherein
the extraction area setting unit sets the extraction area so that a first extraction area corresponding to a first division line on a left side of the road and a second extraction area corresponding to a second division line on a right side of the road are separately set using a first curvature of the first division line and a second curvature of the second division line.

12. The travel division line recognition apparatus according to claim 1, wherein
the extraction area setting unit sets a search line used to search for the edge points in the extraction area so that the number of pixels for searching the edge points becomes less than a predetermined number, regardless of a dimension of the extraction area.

13. A computer-readable storage medium storing a travel division line recognition program for enabling a computer to function as a travel division line recognition apparatus that is mounted in a vehicle, the travel division line recognition apparatus comprising:
a dividing unit that divides an area from which edge points, configuring a division line on a road, are extracted in an image of the road in a periphery of the vehicle that has been captured by an on-board camera into a nearby area within a predetermined distance from the vehicle and a distant area beyond the predetermined distance from the vehicle;
an extraction area setting unit that sets an extraction area from which the edge points are extracted in a portion of the distant area;
a distant edge point extracting unit extracts the edge points within the extraction area set by the extraction area setting unit; and
a distant road parameter estimating unit that estimates distant road parameters based on the edge points extracted by the distant edge point extracting unit, wherein
the extraction area setting unit predicts a position of the division line in the distant area using a curvature of the road that has been acquired in advance, and sets the extraction area so as to include the predicted position of the division line.

14. A travel division line recognition method comprising:
dividing, by a dividing unit of a travel division line recognition apparatus mounted in a vehicle, an area from which edge points, configuring a division line on a road, are extracted in an image of the road in a periphery of the vehicle that has been captured by an on-board camera into a nearby area within a predetermined distance from the vehicle and a distant area beyond the predetermined distance from the vehicle;
setting, by an extraction area setting unit of the travel division line recognition apparatus, an extraction area from which the edge points are extracted in a portion of the distant area;
extracting, by a distant edge point extracting unit of the travel division line recognition apparatus, the edge points within the extraction area set by the extraction area setting unit;
estimating, by a distant road parameter estimating unit of the travel division line recognition apparatus, distant road parameters based on the edge points extracted by the distant edge point extracting unit;
predicting, by the extraction area setting unit, a position of the division line in the distant area using a curvature of the road that has been acquired in advance; and
setting, by the extraction area setting unit, the extraction area so as to include the predicted position of the division line.
